(19) United States
(12) Patent Application Publication
(10) Pub. No.: US 2026/0202196 A1
(43) Pub. Date: Jul. 16, 2026

(54) HOLOGRAPHIC OPTICAL SIGHT AND RANGE FINDER

(71) Applicant: TRULIFE OPTICS LIMITED, London Greater London (GB)

(72) Inventors: Weeraddana Kavindu De SILVA, London Greater London (GB); Benjamin SHERLIKER, London Greater London (GB)

(73) Assignee: TRULIFE OPTICS LIMITED, London Greater London (GB)

(21) Appl. No.: 19/447,784

(22) Filed: Jan. 13, 2026

(30) Foreign Application Priority Data
Jan. 15, 2025 (GB) 2500507.5

(51) Int. Cl. G01C 3/32; G01C 3/04; G02B 5/32; G02B 9/10; G03H 1/00; G03H 1/04

(52) U.S. Cl. CPC G01C 3/32; G01C 3/04; G02B 5/32; G02B 9/10; G03H 1/0005; G03H 1/0406; G03H 2001/0033

(57) ABSTRACT

The present disclosure provides an optical system comprising an objective positive lens and a negative eyepiece lens arranged coaxially to form a Galilean magnification system. A holographic optical element is positioned between the objective positive lens and the negative eyepiece lens. The holographic optical element includes a plurality of reticles, wherein each of the plurality of reticles is a multiplanar reticle focused at a different distance. The system may further include a replay light source configured to illuminate the holographic optical element to generate a converging beam. The converging beam passes through the negative eyepiece lens to create a virtual image at a virtual image distance.

### CROSS REFERENCE TO RELATED APPLICATION

This application claims the benefit under 35 U.S.C. § 119(a) of United Kingdom Application No. GB 2500507.5 filed Jan. 15, 2025, the contents of which are incorporated by reference herein in their entirety.

### FIELD OF DISCLOSURE

The present disclosure relates to optical sighting and range finding systems, and more particularly to an optical system incorporating a Galilean magnification arrangement with a multiplanar holographic reticle, and a method for passive range finding using focus-based distance determination. The present disclosure also relates to a method of manufacturing a holographic optical element as a multiplanar holographic reticle.

### BACKGROUND

Optical sighting systems have long been used for accurate aiming and range finding across various applications including sports such as golf and archery, and engineering applications such as surveying. These systems typically incorporate magnification optics to provide an enlarged view of distant targets, along with reticles or other markers to assist in aiming and range estimation.

Traditional telescopic sights generally utilise either Keplerian or Galilean optical configurations. Keplerian systems employ two positive lenses and create an inverted image that must be re-inverted, while Galilean systems use a positive objective lens and negative eyepiece lens to produce an upright image. Galilean systems offer advantages in terms of compact size, reduced weight, and simplified construction compared to Keplerian designs. Range finding capabilities are commonly implemented through laser-based time-of-flight measurements or stadiametric methods using graduated reticle patterns. Laser rangefinders emit electromagnetic radiation and measure the time taken for reflections to return from the target. Stadiametric ranging relies on comparing known target dimensions against graduated markings in the sight picture.

Several technical challenges exist with current optical sighting and range finding approaches. Laser-based range finding systems can reveal the user's position through their electromagnetic emissions and are susceptible to detection or jamming. Stadiametric ranging methods require prior knowledge of target dimensions and provide only approximate range estimates based on visual comparison.

Traditional reticle implementations in Galilean optical systems face limitations regarding parallax effects and focus consistency across different target distances. Reticles are typically focused at a single fixed distance, leading to parallax errors when viewing targets at other ranges. This can reduce aiming accuracy, particularly in applications requiring precise target engagement at varying distances. Traditional physical reticles, such as those etched on glass or wire crosshairs, are not typically implemented in Galilean optical systems due to inherent limitations in their design. In Galilean systems, the negative eyepiece lens and the positive objective lens configuration create a straightforward, non-inverted image, which is beneficial for compactness and ease of use. However, this configuration complicates the integration of a physical reticle. If a physical reticle were placed within the optical path of a Galilean system, it would need to be positioned at a specific location where it could remain in focus for the user while also aligning accurately with the target image. Achieving this precise placement is challenging because the Galilean design does not naturally accommodate an intermediate focal plane where a physical reticle could be sharply focused and visible in conjunction with the target. This limitation necessitates alternative approaches, such as the use of holographic or projected reticles, which can be more flexibly integrated into the optical path without the need for physical placement within the focal planes of the lenses.

Existing holographic sights generally project reticle patterns focused at a single plane, which limits their effectiveness for range finding applications. While multiple aiming points may be included in these sights, the inability to focus different elements at different distances restricts their utility for accurate range determination and accuracy at different distances.

### SUMMARY

According to an aspect of the present disclosure, an optical sighting system is provided. The optical sighting system includes an objective positive lens and a negative eyepiece lens arranged coaxially to form a Galilean magnification system; a holographic optical element positioned between the objective positive lens and the negative eyepiece lens; and a plurality of reticles recorded in the holographic optical element, wherein each of the plurality reticles is a multiplanar reticle focused at a different distance.

This optical sighting system provides a compact and efficient design that combines magnification with multiplanar reticles, allowing for improved aiming and range estimation capabilities in a single device.

According to other aspects of the present disclosure, the optical sighting system may include one or more of the following features. The plurality of reticles may be arranged to provide aiming point reticles at different and discrete focal distances. The plurality of reticles may be arranged to provide a range finding reticle, the range finding reticle comprising a range finding line extending between each of the plurality of reticles wherein each point on the range finding line is focused at a different and discrete focal distance. The optical sighting system may further include a replay light source configured to illuminate the holographic optical element to generate a converging beam. The converging beam may pass through the negative eyepiece lens to create a virtual image at a virtual image distance. The objective positive lens and negative eyepiece lens may be positioned at a distance equal to the sum of their respective focal lengths. A first aiming reticle may be focused at a first distance, a second aiming reticle may be focused at a second distance, and a third aiming reticle may be focused at a third distance. The holographic optical element may comprise a photosensitive material attached to a glass substrate. The photosensitive material may comprise silver halide, silver halide sensitized gelatin (SHSG) or a photopolymer. Alternatively, the holographic optical element may be formed by a surface relief grating. The first aiming reticle, second aiming reticle, and third aiming reticle may be calibrated to compensate for projectile drop at their respective focal distances. The optical sighting system may further comprise stadia marks extending from at least one of the first aiming reticle, second aiming reticle, and third aiming reticle. Alternatively, the one or more stadia marks may be formed separately from the one or more aiming reticles. The stadia marks may be calibrated for range estimation using target dimensions. The range finding line may enable range determination when both the range finding line and a target appear simultaneously in focus. The range finding line may enable interpolation of ranges between marked gradations based on focus characteristics.

These features enhance the functionality and versatility of the optical sighting system, providing improved accuracy in aiming, range finding, and target acquisition across various distances and conditions.

According to another aspect of the present disclosure, a method of range finding using an optical sighting system is provided. The method includes providing the optical sighting system according to an aspect; illuminating a holographic optical element of the optical system with a replay light source to generate a converging beam; viewing a target through the optical system; and determining a range to the target by identifying a position along a range finding line where both the target and the range finding line appear simultaneously in focus.

This method provides an efficient and accurate means of range finding without the need for additional equipment or complex calculations, improving the user's ability to quickly assess target distances.

According to other aspects of the present disclosure, the method may include one or more of the following features. Determining the range to the target may comprise interpolating between marked gradations on the range finding line when both the target and the range finding line appear simultaneously in focus at a position between the marked gradations. The method may further comprise verifying the determined range using stadia marks extending horizontally from at least one of a first aiming point, a second aiming point, and a third aiming point. Verifying the determined range may comprise measuring an apparent dimension of the target using the stadia marks; and calculating the range using a known dimension of the target and the measured apparent dimension. The method may further comprise viewing the target through a first aiming reticle, a second aiming reticle, or a third aiming reticle after determining the range; and selecting an aiming reticle having a focal distance corresponding to the determined range. The selected aiming reticle may compensate for projectile drop at the determined range. The converging beam may pass through a negative eyepiece lens to create a virtual image at a virtual image distance. The virtual image distance may be adjusted through optical design parameters of the optical system to optimise focus of a reticle pattern.

These additional features of the method provide multiple means of verifying range estimates, compensating for projectile drop, and optimizing the focus of the reticle pattern, thereby enhancing the accuracy and versatility of the range finding process.

According to another aspect of the present disclosure, a method of manufacturing a holographic optical element is provided. The method includes providing a glass substrate; bonding a photosensitive material to the glass substrate; recording a first aiming reticle in the photosensitive material at a first focal distance; recording a second aiming reticle in the photosensitive material at a second focal distance; recording a third aiming reticle in the photosensitive material at a third focal distance; and recording a range finding line in the photosensitive material with a focus that gradually transitions from a near distance to a far distance.

This manufacturing method enables the creation of a complex, multiplanar holographic optical element that integrates multiple aiming reticles and a range finding line into a single component, streamlining the production process and enhancing the capabilities of the resulting optical sighting system.

According to other aspects of the present disclosure, the method of manufacturing a holographic optical element may include additional features that further refine the production process or enhance the functionality of the resulting holographic optical element.

### BRIEF DESCRIPTION OF FIGURES

So that the features of the present disclosure can be understood in detail, a more particular description is made with reference to embodiments, some of which are illustrated in the appended figures. It is to be noted, however, that the appended figures illustrate only typical embodiments and are therefore not to be considered limiting of its scope. The figures are for facilitating an understanding of the disclosure and thus are not necessarily drawn to scale. It will be be noted that the features as illustrated in the figures have been exaggerated for illustration purposes and no dimensions (unless stated in the text or drawings) should be inferred. Advantages of the embodiments will become apparent to those skilled in the art upon reading this description in conjunction with the accompanying figures, in which like reference numerals have been used to designate like elements, and in which:

FIG. 1 illustrates a schematic configuration of a holographic reticle system with a Galilean magnification arrangement, according to aspects of the present disclosure;

FIG. 2a illustrates a holographic optical element incorporating a plurality of aiming reticles and a range finding reticle, according to an embodiment;

FIG. 3 illustrates a series of views demonstrating range finding functionality using a ranging line and focus according to aspects of the present disclosure;

FIGS. 4a to 4c illustrates a series of views demonstrating the parallax free operation of the optical sighting system according to an embodiment;

FIG. 5a illustrates a holographic optical element incorporating stadia marks and aiming points, in accordance with example embodiments; and

FIG. 5b illustrates a holographic optical element incorporating stadia marks combined with a plurality of aiming reticles and a range finding reticle.

### DETAILED DESCRIPTION

As used herein, the term “reticle” may refer to a pattern of fine lines or markings built into the eyepiece of an optical device. In some aspects, a reticle may be used as an aiming point or to take measurements. Reticles may take various forms, including crosshairs, dots, circles, or more complex patterns. Reticles may be created through holographic projection. Reticles may serve multiple purposes in optical systems, such as providing a precise aiming point, assisting in range estimation, or compensating for projectile drop. The design and placement of reticles may be optimized for specific use cases, such as long-range aiming or surveying.

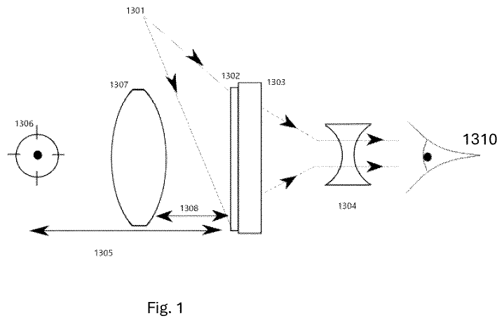

Referring to FIG. 1, there is depicted a schematic configuration for applying a holographic reticle to a Galilean magnification system in accordance with the disclosure. A replay light source 1301 illuminates a holographic optical element 1302, generating a converging beam 1303. The converging beam 1303 passes through a negative eyepiece lens 1304 to create a virtual image at virtual image distance 1305.

The replay light source 1301 may include various illumination sources suitable for reconstructing recorded holograms. Light emitting diodes (LEDs) may serve as replay light sources, providing advantages of low power consumption, compact size, and long operational lifetime. The LEDs may emit light at wavelengths matched to the hologram recording conditions, typically in the visible spectrum between 450-650 nm. Laser diodes may also function as replay light sources, offering high spectral purity and coherence. The laser diodes may operate at specific wavelengths corresponding to the hologram's optimal replay conditions. Single-mode laser diodes may provide enhanced beam quality for precise hologram reconstruction.

In addition to these light sources, the use of a broadband light source coupled with a filter may be considered. A broadband light source can emit light across a wide range of wavelengths, which may be advantageous for versatile holographic playback across different environmental lighting conditions. By incorporating a filter, specific wavelengths can be selectively used to optimize the replay of the holographic reticles according to varying ambient light conditions or specific user requirements. This approach allows for dynamic adjustment of the holographic display without the need to change the light source itself. The filter may be designed to selectively transmit wavelengths that match the recording conditions of the holograms, thereby enhancing the efficiency of the hologram reconstruction. This could potentially improve the visibility and sharpness of the reticles under diverse operational scenarios. Moreover, the use of a broadband light source with a filter may reduce the complexity and cost associated with maintaining multiple types of light sources, as it allows for a single light source to adapt to different playback requirements through simple filter adjustments.

The replay light source 1301 may incorporate optics to control beam divergence. Aspheric lenses or micro-lens arrays may shape the illumination beam profile to optimise hologram replay efficiency.

Temperature-stabilised mounting arrangements may maintain the replay light source 1301 wavelength within design parameters. Thermoelectric cooling elements may regulate operating temperature to prevent wavelength drift. The mounting system may incorporate thermal sensors for closed-loop temperature control. The wavelength of the light emitted by the replay light source 1301 may be controlled by varying the current supplied to the source. This capability allows for fine-tuning of the light wavelength to match the specific recording conditions of the holograms, thereby optimizing the reconstruction of the holographic reticles. Adjusting the current can shift the wavelength slightly, which may be critical for achieving the best possible visibility and sharpness of the holographic images under different viewing conditions. This feature provides flexibility in adapting the optical system to various operational environments without the need for physical changes to the light source or the optical setup.

The replay light source 1301 may include brightness control capabilities to adapt to varying ambient light conditions. Variable current drivers may adjust source intensity over multiple orders of magnitude. Automatic brightness control circuits may respond to ambient light sensors to maintain reticle visibility. Multiple replay light sources may be incorporated to provide redundancy or wavelength diversity. Beam combining optics may merge outputs from separate sources into a single illumination beam. The system may automatically switch between sources to maintain operation if one source fails.

An objective positive lens 1307 and the negative eyepiece lens 1304 are positioned coaxially at a distance equal to the sum of their respective focal lengths. The magnification of the system is determined by the ratio of the focal lengths of the objective positive lens 1307 and negative eyepiece lens 1304. A distance between objective positive lens and holographic optical element 1308 affects the optical performance of the system. This distance 1308 may be adjusted to optimise the focus of a reticle pattern 1306 that is integrated into the optical path through the holographic optical element 1302.

The focus of the reticle pattern may be optimised through several optical and mechanical adjustments. The distance between the objective positive lens 1307 and holographic optical element 1302 may be varied to achieve focus. This adjustment may be accomplished through precision mounting mechanisms that allow controlled positioning of optical components. The replay beam characteristics may influence reticle focus quality. The divergence angle of the replay beam may be adjusted through collimating optics to optimise the reconstruction of the recorded hologram. Beam shaping elements may modify the wavefront profile to enhance focus uniformity across the field of view.

Temperature effects may influence focus stability through thermal expansion of mounting components and changes in optical properties. Temperature compensation mechanisms may maintain consistent focus across operating conditions. These may include thermally-matched mounting materials and active temperature control systems.

The hologram recording geometry may affect the focus characteristics of the reconstructed reticle. The angular relationship between reference and object beams during recording may be selected to optimise replay performance. Multiple exposure techniques may create reticle elements with enhanced focus properties across the desired depth range. The wavelength matching between recording and replay conditions may influence focus quality. Selection of replay light sources with appropriate spectral characteristics may optimise hologram reconstruction. Wavelength stabilization techniques may maintain consistent focus performance.

The reticle pattern 1306 appears superimposed on the target image when viewed through the system. The virtual image of reticle pattern 1306 is formed at virtual image distance 1305, which can be adjusted through the optical design parameters of the system.

The holographic optical element 1302 may comprise a photosensitive material attached to a glass substrate. The photosensitive material may comprise silver halide, silver halide sensitized gelatin (SHSG) or a photopolymer. Alternatively, the holographic optical element 1302 may be formed by a surface relief grating. Silver halide materials provide high diffraction efficiency and sensitivity across visible wavelengths, while photopolymer materials offer enhanced environmental stability and reduced processing requirements. Prior to material deposition, a glass substrate undergoes precision cleaning using a multi-step process comprising ultrasonic cleaning in detergent solution, followed by solvent rinses and plasma treatment to ensure surface adhesion. A selected photosensitive material is bonded to the cleaned substrate using an optically matched adhesive having a refractive index within 0.01 of both materials to minimise internal reflections.

Multiple holograms are recorded in holographic optical element 1302 through sequential exposures using a multiplexing technique. Each exposure utilises a reference beam and an object beam configured at specific angles and distances to achieve the desired focal plane locations.

For silver halide materials, beam ratios between 3:1 and 10:1 (reference beam: object beam) are maintained with exposure energies of 50-200 μJ/cm² per recording. Processing includes development in ascorbic acid developer, followed by bleaching to create phase holograms. Photopolymer materials utilise beam ratios of 1:1 to 3:1 with exposure energies of 20-100 mJ/cm² and require UV post-exposure curing. The skilled person will appreciate that the above recording energies are provided as non-limiting examples.

Environmental protection of holographic optical element 1302 is achieved through encapsulation using optical grade epoxy between protective glass cover plates. The encapsulant maintains an air gap of 0.1-0.5 mm to prevent contact with the holographic material while providing hermetic sealing. Anti-reflection coatings on external surfaces reduce spurious reflections.

Quality control measures include interferometric testing of wavefront quality, diffraction efficiency measurements at multiple wavelengths, and environmental cycling to verify stability. Focal plane locations are verified using precision optical metrology equipment to ensure accurate placement of recorded elements.

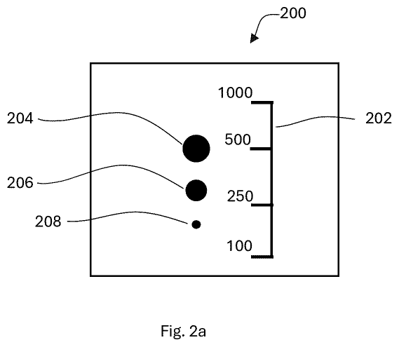

Referring to FIG. 2, a holographic optical element 200, of the type mentioned above in relation to FIG. 1, incorporates multiple reticle patterns positioned at different focal planes. A range finding line 202 extends vertically through holographic optical element 200, with a focus that gradually transitions from near to far distances. The gradual focus transition enables precise range determination by allowing a user to identify the point where both the target and range finding line 202 appear simultaneously in focus.

The skilled person will appreciate that the aiming reticles may be focused at various distances to accommodate different operational requirements. For example, the aiming reticles may be configured with focal distances of 100 meters for close-range engagements, 250 meters for intermediate ranges, 500 meters for extended range applications, and 1000 meters for long-distance observation. The spacing between focal planes may be adjusted based on intended use cases, with smaller increments between closer distances where precise range determination is particularly valuable. The range finding line 202 may transition smoothly through these distances, enabling accurate range determination across the entire range of operation.

Holographic optical element 200 includes a first reticle 204, a second aiming reticle 206, and a third aiming reticle 208 positioned at different focal planes and the skilled person will appreciate that any number of reticles may be provided dependent on the focal distances required. For example, the first aiming reticle 204 may be focused at 100 meters, the second aiming reticle 206 at 200 meters, and the third aiming reticle 208 at 300 meters, though other focal distances may be selected based on intended usage scenarios. Each aiming reticle appears in sharp focus only when viewing a target at its corresponding focal distance, providing parallax-free aiming at that specific range.

The angular subtense of first aiming reticle 204, second aiming reticle 206, and third aiming reticle 208 may be optimised for different target sizes at their respective focal distances. For example, first aiming reticle 204 may subtend a larger angle to aid target aquisition for closer targets, while third aiming reticle 208 may subtend a smaller angle to maintain accuracy at extended ranges. As used herein, the term “subtense” or “angular subtense” refers to the angle formed between two lines extending from an observer's eye to the opposite extremities of a viewed object or reticle element. The angular subtense may be measured in angular units such as degrees, milliradians (mrad), or minutes of angle (MOA). For example, a reticle element with a larger angular subtense will appear to occupy more of the field of view than one with a smaller angular subtense when viewed through the optical system. The angular subtense of reticle elements may be specifically designed to correspond to standard target dimensions at particular ranges to facilitate range estimation.

First aiming reticle 204, second aiming reticle 206, and third aiming reticle 208 may be calibrated to compensate for projectile drop at their respective focal distances. The vertical spacing between aiming reticles corresponds to predicted projectile trajectories, allowing for accurate target engagement across multiple distances without manual adjustment. When a projectile is fired, it follows a ballistic trajectory influenced by gravity, which causes the projectile to drop below its initial line of sight as it travels downrange. The amount of drop may vary based on factors including projectile velocity, ballistic coefficient, and atmospheric conditions. At greater distances, the vertical deviation from the line of sight may increase in a non-linear manner. The trajectory may be modeled using ballistic calculations that account for these variables. For example, a projectile with an initial velocity of 800 meters per second may drop approximately 25 centimeters at 200 meters and 80 centimeters at 300 meters under standard atmospheric conditions. The actual drop values may differ based on the specific projectile and environmental parameters. The vertical spacing between aiming reticles may incorporate predetermined drop compensation values for standard projectile types. This allows a user to select the appropriate aiming reticle based on the determined target range without manually adjusting for projectile drop. For example, when engaging a target at 300 meters, the third aiming reticle 208 may be positioned below the first aiming reticle 204 by an offset that matches the expected projectile drop at that distance.

The holographic optical element 1302 may record multiple aiming points with vertical offsets calibrated for different ammunition types. Users may select reticle patterns optimised for their specific ammunition's ballistic characteristics. The spacing between aiming points may account for variations in projectile velocity, weight, and aerodynamic properties.

Temperature, altitude, and atmospheric pressure may affect projectile trajectories. The system may include reference data allowing users to adjust their point of aim based on environmental conditions. Multiple sets of aiming points may be incorporated to accommodate different environmental scenarios.

The brightness and contrast of range finding line 202, first aiming reticle 204, second aiming reticle 206, and third aiming reticle 208 may be optimised for various ambient lighting conditions through control of the holographic recording parameters. Multiple exposure levels during hologram recording create reticle elements that maintain visibility across a range of lighting scenarios.

The holographic recording process utilises multiple exposure levels to optimise visibility of reticle elements across varying ambient light conditions. During manufacture, the holographic optical element 1302 is exposed to different intensity levels of the recording beams, typically ranging from 50-200 μJ/cm² for silver halide materials and 20-100 mJ/cm² for photopolymer materials. This creates a layered recording with different diffraction efficiencies that become visible under different illumination conditions. For example, lower exposure levels create subtle reticle features that remain visible in bright daylight without overwhelming the target image, while higher exposure levels ensure the reticle remains sufficiently bright for use in low-light conditions. The replay light 1301 source intensity can be adjusted to optimise reticle visibility based on ambient lighting, with typical brightness variations of 34-17000 candela per meter squared achievable through power adjustment to the illumination source. This multi-exposure approach ensures that critical aiming and ranging features remain discernible across the full range of expected operational lighting conditions, from bright daylight to dusk or dawn scenarios, without requiring electronic brightness control systems.

The focal planes of first aiming reticle 204, second aiming reticle 206, and third aiming reticle 208 maintain their relative spacing when viewed through the magnification system. Compensation factors in the holographic recording geometry account for the optical effects of system magnification to preserve accurate range indication and projectile drop compensation. The multiplanar reticles may be recorded in the holographic optical element using a sequential exposure technique. This process may involve multiple recording steps to create reticle patterns at different focal planes within the holographic material.

For each reticle, the recording setup may be configured with specific geometries to achieve the desired focal distance. The reference beam and object beam may be adjusted to create interference patterns that, when reconstructed, produce a virtual image at the intended focal plane. The angular relationship between these beams may be precisely controlled to determine the focal distance of each recorded reticle.

The recording process may utilize spatial light modulators to generate the desired reticle patterns for each exposure. These modulators may allow for dynamic adjustment of the reticle design between exposures without requiring physical mask changes. This approach may enable efficient recording of multiple reticle patterns with varying complexities and focal distances.

Between exposures for different reticles, the holographic material may be repositioned or the optical setup may be adjusted to change the recording geometry. This may allow for the creation of distinct focal planes for each reticle within the same holographic element. The positioning system may incorporate high-precision translation stages to ensure accurate placement of each recorded element. The exposure time and intensity for each reticle recording may be individually optimized based on the desired brightness and diffraction efficiency of the final element. This may involve varying the exposure parameters between different reticle recordings to achieve optimal visibility for each focal plane.

To create the gradually transitioning focus of the range finding line, the recording process may employ a continuous exposure technique. The object beam focusing optics may be dynamically adjusted during the exposure to create a smooth transition in focal distance along the length of the range finding line. This may result in a reticle element that appears in focus at different distances depending on the viewing position along its length. The recording process may incorporate compensation for optical effects introduced by the Galilean magnification system. This may involve pre-distorting the recorded patterns to ensure that the reconstructed images appear correctly positioned and scaled when viewed through the complete optical system.

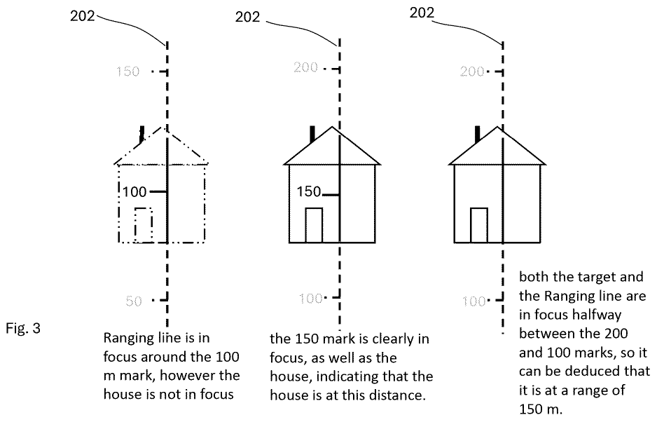

Range finding line 202 shown in FIG. 3 corresponds to range finding line 202 shown in FIG. 2, providing focus-based distance determination capabilities through the optical system. The range finding line 202 enables passive range finding through focus-based distance determination. The range finding line 202 incorporates a gradual focus transition from near to far distances, allowing precise range determination when both range finding line 202 and a target appear simultaneously in focus. When viewing through the magnification system, range finding line 202 appears clearly focused at specific distances corresponding to the target range. For example, when range finding line 202 and a target, in this case a house, at 100 meters both appear in sharp focus, range finding line 202 indicates the target distance as 100 meters. Similarly, when range finding line 202 and a target at 200 meters simultaneously achieve focus, range finding line 202 confirms the 200-meter range. Range determination between marked gradations utilises interpolation based on the focus characteristics of range finding line 202. For instance, when range finding line 202 and a target appear simultaneously focused at a point halfway between the 100-meter and 200-meter markings, the target range corresponds to 150 meters. This interpolation capability enables precise range determination across the continuous focusing range of range finding line 202.

The focus-based range finding method operates independently of target dimensions or atmospheric conditions that may affect the focus-based range finding capabilities. The focus-based range finding method operates independently of target dimensions that may affect traditional laser-based systems. Range finding accuracy maintains consistency across varying target sizes and shapes since the method relies solely on optical focus characteristics rather than target geometry or reflected signals.

Environmental factors affecting range finding accuracy include ambient light levels and atmospheric turbulence. Optimal range finding performance occurs under clear atmospheric conditions with sufficient ambient illumination to discern focus characteristics. Atmospheric effects such as heat mirage may influence focus discrimination at extended ranges.

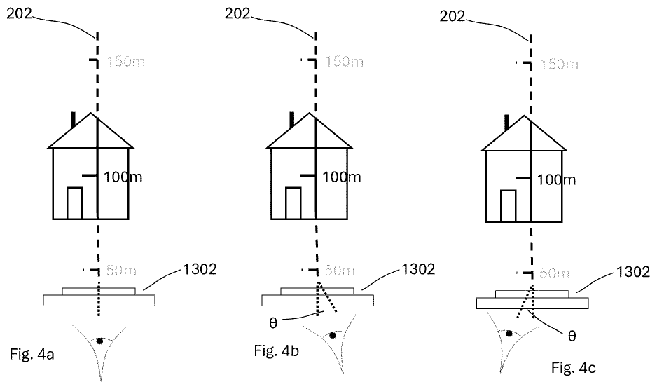

The optical system may provide parallax-free aiming when the target is in focus as illustrated in FIGS. 4a to 4c. Parallax refers to the apparent displacement of an object when viewed from different positions. In optical sighting systems, parallax can cause aiming errors if the reticle and target are not in the same focal plane. When the target is in focus, it may be located at the same optical distance as the focal plane of the reticle. This alignment may ensure that the reticle appears to be superimposed directly on the target, regardless of small movements of the user's eye position behind the eyepiece. As a result, the aiming point may remain consistent and accurate even if the user's eye is not perfectly centered behind the optic.

The multiplanar nature of the holographic reticles in this system may allow for parallax-free aiming at multiple distances. For example, when using first aiming reticle 204 to engage a target at its corresponding focal distance, the reticle and target may both be in sharp focus simultaneously. This simultaneous focus may indicate that the reticle and target are in the same focal plane, eliminating parallax error for that specific range as illustrated in FIGS. 4a to 4c. In FIGS. 4a to 4c the reticle and target are in focus at 100 m. In FIG. 4a, the users eye is head on or centered on the ranging line 202 and the skilled person would understand that even if the target and reticle are not in focus no parallax error would occur. FIGS. 4b and 4c, the user's eye is displaced by an angle θ, either side with respect to the ranging line 202, however simultaneous focus indicates that the reticle and target are in the same focal plane, eliminating parallax error.

As the user transitions to longer ranges, they may switch to second aiming reticle 206 or third aiming reticle 208. Each of these reticles are also arranged to be parallax-free at their respective focal distances. This feature may allow the user to maintain accurate, parallax-free aiming across multiple engagement distances without the need for manual parallax adjustment. The ranging line 202 may also contribute to parallax-free operation. As the user aligns the in-focus section of the ranging line with an in-focus target, they may be effectively matching the focal planes of the reticle and target. This alignment may naturally result in a parallax-free sight picture at the determined range.

The parallax-free nature of the sighting system when the target is in focus may provide several advantages. It may increase first-shot accuracy by eliminating one source of aiming error. Additionally, it may allow for faster target acquisition as the user does not need to ensure perfect eye positioning to achieve an accurate sight picture.

The relationship between system magnification and range finding accuracy demonstrates that increased magnification enhances the ability to discriminate fine focus differences, potentially improving range determination precision. However, higher magnification reduces the field of view, requiring additional time for target acquisition.

Effective range limits depend on factors including ambient lighting, atmospheric conditions, and target contrast. Under optimal conditions, range finding capability extends from close distances to the maximum focal distance of ranging line 302. Range finding accuracy may decrease at extended distances due to reduced focus discrimination and atmospheric effects.

The passive nature of the focus-based range finding method provides advantages in situations where active ranging emissions may compromise position.

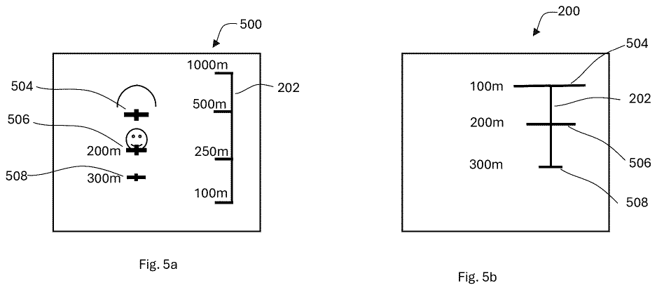

Referring to FIG. 5a, a holographic optical element 500 incorporates stadia marks integrated with multiple aiming points and a range finding line 202. A first aiming point 504, a second aiming point 506, and a third aiming point 508 are positioned vertically along range finding line 202, with stadia marks extending from each aiming point.

The stadia marks comprise lines of predetermined length or heights extending from first aiming point 504, second aiming point 506, and third aiming point 508. Each set of stadia marks corresponds to known target dimensions such as width and/or height at specific distances, enabling range estimation through visual comparison of target size to stadia mark spacing.

First aiming point 504 includes stadia marks calibrated for targets at close range, while second aiming point 506 and third aiming point 508 incorporate progressively wider stadia mark spacing for medium and long-range targets respectively. The stadia mark spacing may be calibrated for standard target dimensions such as 1-meter, 2-meter, or custom-sized reference objects depending on the nature of the target. The skilled person will also appreciate that the stadia marks may be combined with the range finding line 202 as illustrated in FIG. 5b.

The combination of stadia marks with range finding line 202 provides complementary range finding capabilities. Users may employ stadia marks for rapid range estimation when target dimensions are known, while using range finding line 202 for precise range determination through focus-based methods when target dimensions are uncertain or variable. In surveying applications, the stadia marks enable rapid distance measurement to objects of standardised size, such as survey poles or construction elements. For sporting applications such as golf, the stadia marks may be calibrated to standard flag heights or green dimensions for range estimation to course features. The stadia marks maintain visibility across varying light conditions through optimisation of holographic recording parameters during manufacture of holographic optical element 500. Multiple exposure levels create stadia marks with sufficient contrast for use in both bright daylight and low-light conditions.

Environmental factors affecting stadia mark usage include atmospheric conditions and target contrast. Clear atmospheric conditions optimise visibility of both target and stadia marks, while atmospheric distortion may reduce accuracy at extended ranges. The stadia marks provide range estimation capabilities independent of power sources or electronic systems, offering reliable backup range finding functionality. Users may verify ranges obtained through focus-based methods using range finding line 202 by cross-referencing with stadia mark measurements.

Particular and preferred aspects of the disclosure are set out in the accompanying independent claims. Combinations of features from the dependent and/or independent claims may be combined as appropriate and not merely as set out in the claims. The scope of the present disclosure includes any novel feature or combination of features disclosed therein either explicitly or implicitly or any generalisation thereof irrespective of whether or not it relates to the claimed disclosure or mitigate against any or all of the problems addressed by the present disclosure. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Features which are described in the context of separate embodiments may also be provided in combination in a single embodiment. Conversely, various features which are, for brevity, described in the context of a single embodiment, may also be provided separately or in any suitable sub combination.

1. An optical sighting system, comprising:
an objective positive lens and a negative eyepiece lens arranged coaxially to form a Galilean magnification system;
a holographic optical element positioned between the objective positive lens and the negative eyepiece lens;
a plurality of reticles recorded in the holographic optical element, wherein each of the plurality reticles is a multiplanar reticle focused at a different distance.

2. The optical sighting system of claim 1, wherein the plurality of reticles are arranged to provide aiming point reticles at different and discrete focal distances.

3. The optical sighting system of claim 1, wherein each of the plurality of reticles are arranged to provide a range finding reticle, the range finding reticle comprising a range finding line extending between each of the plurality of reticles wherein each point on the range finding line is focused at a different and discrete focal distance.

4. The optical sighting system of claim 1, further comprising a replay light source configured to illuminate the holographic optical element to generate a converging beam.

5. The optical sighting system of claim 4, wherein the converging beam passes through the negative eyepiece lens to create a virtual image at a virtual image distance.

6. The optical sighting system of claim 1, wherein the objective positive lens and negative eyepiece lens are positioned at a distance equal to the sum of their respective focal lengths.

7. The optical sighting system of claim 1, wherein a first aiming reticle is focused at a first distance, a second aiming reticle is focused at a second distance, and a third aiming reticle is focused at a third distance.

8. The optical sighting system of claim 1, wherein the holographic optical element comprises a photosensitive material attached to a glass substrate, and wherein the photosensitive material comprises one of silver halide, SHSG or photopolymer.

9. The optical sighting system of claim 1, wherein the first aiming reticle, second aiming reticle, and third aiming reticle are calibrated to compensate for projectile drop at their respective focal distances.

10. The optical sighting system of claim 1, further comprising stadia marks extending from at least one of the aiming reticles, and wherein the stadia marks are calibrated for range estimation using target dimensions.

11. The optical sighting system of claim 1, wherein the range finding line enables range determination when both the range finding line and a target appear simultaneously in focus, and wherein the range finding line enables interpolation of ranges between marked gradations based on focus characteristics.

12. A method of range finding using an optical sighting system, the method comprising:
providing the optical sighting system of claim 1;
illuminating a holographic optical element of the optical system with a replay light source to generate a converging beam;
viewing a target through the optical system; and
determining a range to the target by identifying a position along a range finding line where both the target and the range finding line appear simultaneously in focus.

13. The method of claim 12, wherein determining the range to the target comprises interpolating between marked gradations on the range finding line when both the target and the range finding line appear simultaneously in focus at a position between the marked gradations.

14. The method of claim 12, further comprising verifying the determined range using stadia marks extending from at least one of a first aiming point, a second aiming point, and a third aiming point.

15. The method of claim 14, wherein verifying the determined range comprises: measuring an apparent height of the dimension using the stadia marks; and calculating the range using a known dimension of the target and the measured apparent dimension.

16. The method of claim 15, further comprising:
viewing the target through a first aiming reticle, a second aiming reticle, or a third aiming reticle after determining the range; and
selecting an aiming reticle having a focal distance corresponding to the determined range.

17. The method of claim 16, wherein the selected aiming reticle compensates for projectile drop at the determined range.

18. The method of claim 12, wherein the converging beam passes through a negative eyepiece lens to create a virtual image at a virtual image distance.

19. The method of claim 18, wherein the virtual image distance is adjusted through optical design parameters of the optical system to optimise focus of a reticle pattern.

20. A method of manufacturing a holographic optical element, comprising:
providing a glass substrate;
bonding a photosensitive material to the glass substrate;
recording a first aiming reticle in the photosensitive material at a first focal distance;
recording a second aiming reticle in the photosensitive material at a second focal distance;
recording further aiming reticles in the photosensitive material at the further focal distances; and
recording a range finding line in the photosensitive material with a focus that gradually transitions from a near distance to a far distance.
